(19) United States
(12) Patent Application Publication
(10) Pub. No.: US 2011/0136084 A1
(43) Pub. Date: Jun. 9, 2011

(54) NUTRITION TRACKING TOOL

(76) Inventor: CHRISTINE A. SCAPINI, Grosse Pointe Woods, MI (US)

(21) Appl. No.: 12/631,815

(22) Filed: Dec. 5, 2009

(51) Int. Cl. G09B 19/00

(52) U.S. Cl. 434/127

(57) ABSTRACT

A tool for tracking dietary consumption includes a frame defining a first region representing dietary elements yet to be consumed during a predefined time period, such as a calendar day, and a second region representing dietary elements which have already been consumed during the predefined time period. The tool also includes a plurality of predefined paths bridging the first and second regions and representing selected dietary food groups, additional consumptive elements such as fluids, and physical activities. Tokens associated with each path and representative of a unit consumption or performance are constrained to move serially along the path from one region to another, to thereby advantageously record and otherwise provide a visual confirmation of the satisfaction of the corresponding requirement. The number of tokens in each set of tokens is customized to reflect individualized dietary and other requirements.

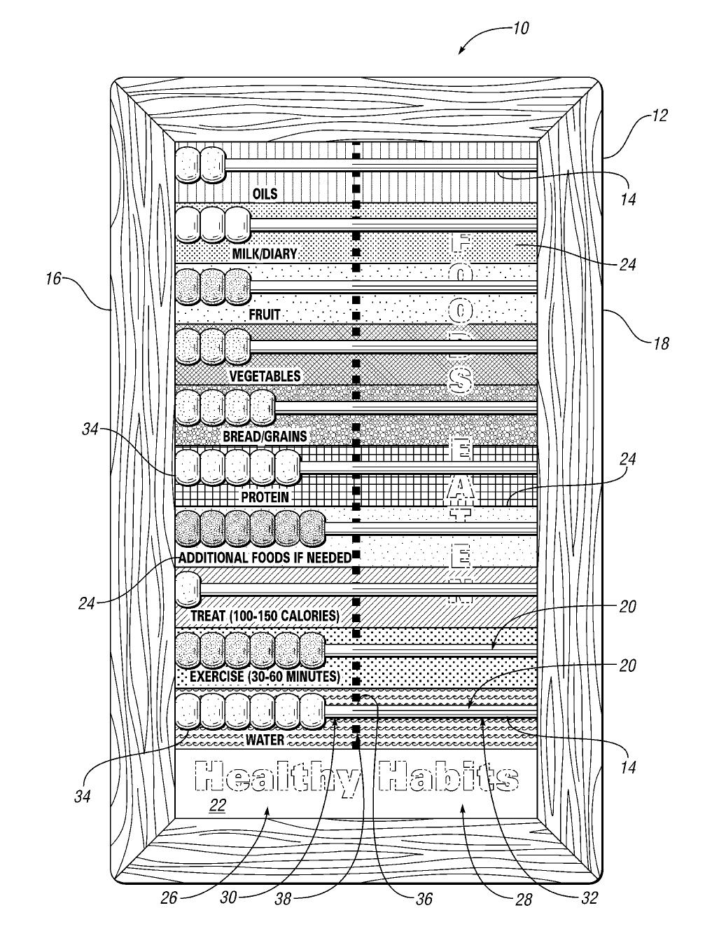

### FIELD OF THE INVENTION

The invention relates to tools and devices used to track dietary consumption, for example, for purposes of improving nutrition, and for teaching and maintaining sound eating habits.

### BACKGROUND OF THE INVENTION

It is well established that a “balanced diet” is beneficial, for example, to promote proper growth and health maintenance, to enhance physical and mental performance, to reduce the risk of chronic disease, and to control weight. To that end, the United States Food and Drug Administration has for years published the Food Guide Pyramid identifying various recommended food groups and the number of servings of foods belonging to the food groups which should be consumed daily. While the Food Guide Pyramid and other similar graphical aids have proven useful as teaching aids, such generic tools are not well suited to facilitate a given individual's efforts to accurately track his or her daily food consumption, particularly where that individual's dietary requirements differ from the norm, i.e., are appropriately adjusted to account for age, height, weight, gender, and other suitable factors. Such tools also fail to provide for the tracking of other aspects related to a healthy lifestyle, such as an individual's correlative progress toward achieving a desired level of daily exercise.

### SUMMARY OF THE INVENTION

In accordance with an aspect of the invention, a tool for tracking dietary consumption includes a frame defining a first region representing dietary elements yet to be consumed during a predefined time period, such as a calendar day, and a second region representing dietary elements which have already been consumed during the predefined time period. The tool also includes a plurality of predefined paths bridging the first and second regions, such that each path includes a first section associated with the first region and a second section associated with the second region. The predefined paths represent selected dietary food groups and, preferably, additional consumptive elements such as a recommended fluids, and at least one performance-based element, for example, representative of a physical activity or user reward.

The tool further includes a set of tokens associated with each predefined path, each token being representative of consumption of a reference amount of a selected dietary food group, consumption of a reference amount of a recommended fluid, performance of a predefined activity, or satisfaction of an earned reward. Each such set of tokens is retained on its respective path and is further constrained to move serially along the path between its first and second sections. The number of tokens in each set of tokens is preferably customized to reflect the individual dietary requirements of a given user.

In accordance with another aspect of the invention, each predefined path preferably includes a transition between its first and second sections that is adapted to prevent unintended movement of the tokens between the two regions, while otherwise permitting intended movement of a given token across the transition between the first and second path sections, for example, upon consumption or performance of the associated dietary and/or other element.

By way of example, in a first exemplary embodiment, the predetermined paths are defined by a plurality of rods extending between a respective pair of locations on the frame, such that the rods are generally coplanar and generally parallel-spaced with one another. A backing board supported by the frame in spaced relation behind the rods includes indicia corresponding to the first and second regions, such that the indicia are viewable past the rods, to thereby associate the first section of each rod with dietary elements yet to be consumed, and the second section of each rod with dietary elements which have already been consumed. In this first exemplary embodiment, each token is a bead supported for axial sliding movement on the rod, one after another. A surface feature on the rod at the transition prevents the unintentional or “free” movement of a given bead from the first rod section to the second rod section, as well as the unintentional movement of the bead back to the first rod section from the second rod section.

In accordance with another aspect of the invention, in the first exemplary embodiment, the beads are color- and/or pattern-coordinated with the indicia on the backing board to facilitate use of the tool, for example, by children or the elderly; to this end, each set of beads is preferably provided with its own unique color or pattern, which preferably coordinates with the backing board indicia.

From the foregoing, it will be appreciated that a tool in accordance with the invention advantageously permits the recording of a given user's progress toward meeting a personalized goal with respect to consumption of dietary elements within the several food groups, as well as consumption of recommended fluids such as glasses of water, the performance of an identified physical activity, and the satisfaction of an earned reward, while providing further visual emphasis regarding such progress. As noted above, the number of tokens within each set, i.e., the number of tokens associated with a given dietary element, beverage, or activity, is advantageously customized for a given user, for example, at the time of assembly of the tool, to reflect the individualized dietary and exercise requirements of different tool users.

Other objects, features, and advantages of the present invention will be readily appreciated upon a review of the subsequent description of the preferred embodiment and the appended claims, taken in conjunction with the accompanying Drawing.

### BRIEF DESCRIPTION OF THE DRAWING

The FIGURE is a front view of an exemplary nutrition and activity tracking tool in accordance with the invention.

### DETAILED DESCRIPTION OF THE EXEMPLARY EMBODIMENT

Referring to the FIGURE, an exemplary nutrition and activity tracking tool 10 in accordance with the invention includes a frame 12, and a plurality of generally-coplanar, parallel-spaced rods 14 bridging the sides 16, 18 of the frame 12 to thereby define a plurality of fixed paths 20 on the frame 12. The paths 20 represent selected dietary food groups, including oils, milk/dairy, fruit, vegetables, protein, and an additional open category useful for customizing food consumption for a given user; as well as beverage consumption and physical activity performed. It will be appreciated that, while the exemplary tool 10 employs a single-column array of rods 14 to thereby define its several paths 20, the invention contemplates other frame-and-rod configurations including the use, for example, of a vertical frame element (not shown) to thereby define a multi-column array of rods/paths, or alternatively the use of a frame hub (also not shown) defining a radial rod/path configuration.

Returning to the FIGURE, a backing board 22 supported by the frame 12 in spaced relation behind the rods 14 includes indicia 24, viewable past the rods 14, which defines a first region 26 representing dietary elements yet to be consumed and activities yet to be performed, for example, during a given day (as seen on the left in the FIGURE), and a second region 28 representing dietary elements and activities which have already been consumed or performed during the day (as seen on the right in the FIGURE). In this manner, a first section 30 of each rod 14 is associated with dietary elements yet to be consumed and activities yet to be performed, and a second section 32 of each rod 14 with dietary elements or activities which have already been consumed or performed.

One or more beads 34 are supported for axial sliding movement, one after another, on each rod 14. The number of beads on a given rod 14 and, hence, the number of beads 34 associated with a given path 20, is customized to the individual dietary and activity requirements of an intended user, for example, based on such inputs as user age, height, weight, and gender, with each bead 34 represents a serving size or reference amount of its respective dietary element or activity.

Thus, for an exemplary adult, the exemplary tool 10 might include: one bead representing a 150-calorie treat or other reward earned; two beads each representing a teaspoon of healthy oils; three beads each representing a serving of milk or dairy; three beads each representing three pieces (up to 2 cups) of fresh, frozen, or canned fruit; three beads each representing a serving of vegetables (two and one-half cups); five beads each representing a one-ounce serving of protein; eight beads each representing an eight-ounce serving of water; and six beads each representing ten minutes of physical activity. It is noted that, in the exemplary tool 10, each rod end is permanently affixed to the frame 12 after the desired number of beads 34 are threaded onto each rod 14, to thereby prevent a subsequent loss of beads 34. Additionally, the beads 34 are preferably color-coordinated with the indicia 24 on the backing board 22 to facilitate use of the tool 10, for example, by children or the elderly; to this end, each set of beads 34 has a different color that is preferably visually associated with the dietary element or food group represented by the bead 34 (e.g., white beads for milk, green beads for vegetables, and light blue beads for water).

In use, as various foods are consumed during a given day, the user slides the appropriate bead or beads from the first (left) region 26 to the second (right) region 28 in satisfaction of its associated daily nutritional or other requirement.

Referring again to the FIGURE, a surface feature 36 is defined on each rod 14 at a transition 38 between each rod's first and second sections 30,32. The surface feature 36 prevents the unintended, or “free,” movement of a given bead 34 from the first rod section 30 to the second rod section 32, or back again. While the surface feature 36 on each rod 14 of the exemplary tool 10 is conveniently defined by small amount of an applied epoxy resin, it will be appreciated that the invention contemplates use of other suitable transition elements to prevent such unintended movement of a bead 34 across a given rod transition 38 including, without limitation, another applied element such as a piece of tape, an integrally-formed rod feature such as a flared radius, or an elastic member on the frame (not shown) which extends generally perpendicularly across the set of rods 14 to thereby define a movable barrier preventing such unintended bead movement.

While the above description constitutes the preferred embodiment, it will be appreciated that the invention is susceptible to modification, variation and change without departing from the proper scope and fair meaning of the subjoined claims. For example, while the exemplary tool 10 employs a plurality of rods 14 to define the several predetermined paths 20, it will be appreciated that the invention likewise contemplates use of tracks or other path configurations that suitably retain and otherwise constrain the movement of the tokens such that the tokens associated with a given path can be deliberately moved in series along the given path once the dietary element or activity associated with the token is consumed or performed, and then back again to thereby reset the tool for reuse. By way of further example, the invention contemplates practicing the invention on an electronic device, such as a handheld computer incorporating a touch-screen graphical user interface visually framing the several recited paths, associated regions, and sets of tokens, with the tokens in a given set are serially movable along the set's respective path, for example, responsive to movement of a fingertip or stylus to thereby provide a visual indication of the user's progress toward his/her consumption and performance goals. To this end, it will be appreciated that, in the context of implementation of the invention on an electronic device such as the above-described handheld computer, the intended transition may be implemented by requiring a predefined engagement of the user's finger or stylus with the touch screen to thereby confirm an intentional, rather than unintentional, movement of a given electronic token along its respective path. A magnetic insert or strip may also be added to the frame 12, such that the tool is adapted to magnetically attach to an appropriate surface, thereby enhancing its use in providing a visual indication of the progress made by the user in achieving his or her goals of a balanced diet and a healthy lifestyle.

What is claimed is:

1. A tool for tracking dietary consumption comprising:
a frame defining a first region representing dietary elements yet to be consumed and a second region representing dietary elements which have been consumed;
a plurality of predefined first paths bridging the first and second regions, each path being associated with consumption of a selected dietary food group, and each first path including a first section associated with the first region and a second section associated with the second region; and
a set of first tokens associated with each first path, each first token being representative of consumption of a reference amount of the selected dietary food group, the first tokens being constrained to move serially along the respective first path from the first section of the respective first path to the second section of the respective first path.

2. The tool of claim 1, wherein each first path is defined by a rod extending between a respective pair of locations on the frame.

3. The tool of claim 2, wherein the rods are fixed in the frame.

4. The tool of claim 2, wherein the rods are generally coplanar and generally parallel-spaced with one another.

5. The tool of claim 2, further including a backing board supported by the frame in spaced relation behind the rods, the backing board including indicia corresponding to the first and second regions, the indicia being viewable past the rods.

6. The tool of claim 1, wherein the tokens are supported for axial sliding movement on each rod.

7. The tool of claim 2, wherein the tokens of each set of tokens share a unique color.

8. The tool of claim 1, further including a transition on each first path defined between the first and second sections of the each first path, the transition being adapted to prevent unintended first token movement between the first section of the path and the second section of the path.

9. The tool of claim 8, wherein each first path is defined by a respective rod extending between a respective pair of locations on the frame, and wherein the transition on each first path is defined by a surface feature on each rod.

10. The tool of claim 1, further including a predefined second path bridging the first and second regions, the second path being representative of consumption of a reference amount of a recommended fluid, and the second path including a first section associated with the first region and a second section associated with the second region; and a set of second tokens associated with the second path, the second tokens being adapted to move serially along the second path from the first section of the second path to the second section of the second path.

11. The tool of claim 1, further including a predefined third path bridging the first and second regions, the third path being representative of performance of a predefined activity, and the third path including a first section associated with the first region and a second section associated with the second region; and a set of third tokens associated with the third path, the third tokens being adapted to move serially along the respective third path from the first section of the third path to the second section of the third path.

12. A tool comprising:
a frame defining a first region representing dietary elements yet to be consumed and a second region representing dietary elements which have been consumed;
a plurality of rods supported by the frame so as to bridge the first and second regions, each rod being associated with a selected one of the group consisting of a plurality of dietary food groups, a recommended fluid, and a physical activity, each rod having a first section associated with the first region and a second section associated with the second region; and
a set of tokens supported for sliding movement on each rod, each token being representative of one of the group consisting of the consumption of a reference amount of the selected dietary food group, the consumption of a reference amount of the recommended fluid, and the performance of a reference amount of the physical activity, the tokens of each set of tokens being adapted to move serially along the respective rod from a first section of the respective rod to the second section of the respective rod.

13. The tool of claim 12, wherein the rods are fixed in the frame, and the tokens of each set of tokens are supported for axial sliding movement on the respective rod.

14. The tool of claim 12, wherein the rods are supported by the frame in a generally coplanar and generally parallel-spaced relation with one another.

15. The tool of claim 12, further including a transition on each rod defined between the first and second sections of the rod, the transition being adapted to prevent unintended token movement between the first and second sections of the rod.

16. The tool of claim 15, wherein the transition on each rod includes a surface feature on each rod adapted to engage the tokens to thereby prevent unintended movement of the tokens along the rod.

17. The tool of claim 12, further including a backing board supported by the frame in spaced relation behind the rods, the backing board including indicia corresponding to the first and second regions, the indicia being viewable past the rods.

18. The tool of claim 12, wherein the tokens of each set of tokens share a unique color.
